(19) United States
(12) Patent Application Publication
(10) Pub. No.: US 2019/0204910 A1
(43) Pub. Date: Jul. 4, 2019

(54) SACCADIC BREAKTHROUGH MITIGATION FOR NEAR-EYE DISPLAY

(71) Applicant: Microsoft Technology Licensing, LLC, Redmond, WA (US)

(72) Inventors: Robert Thomas HELD, Seattle, WA (US); Christopher Maurice MEI, Redmond, WA (US); Christopher Charles AHOLT, Newcastle, WA (US); Nava Kayla BALSAM, Woodinville, WA (US); Shivkumar SWAMINATHAN, Redmond, WA (US); Jeffrey N. MARGOLIS, Seattle, WA (US)

(73) Assignee: Microsoft Technology Licensing, LLC, Redmond, WA (US)

(21) Appl. No.: 15/860,528

(22) Filed: Jan. 2, 2018

(51) Int. Cl. G06F 3/01; G06T 11/60; G02B 27/01

(52) U.S. Cl. CPC G06F 3/013; G06T 11/60; G02B 27/0172; G02B 2027/0118; G02B 2027/0138; G02B 2027/014; G02B 2027/0187; G02B 27/0179

(57) ABSTRACT

Via a near-eye display, one or more pre-saccade image frames are displayed to a user eye. Based on a detected movement of the user eye, the user eye is determined to be performing a saccade. One or more saccade-contemporaneous image frames are displayed with a temporary saccade-specific image effect not applied to the pre-saccade image frames.

### BACKGROUND

A saccade is a rapid eye movement from one position to another, typically performed by both eyes at once. Saccades are often performed when an observer quickly changes their focus from one part of an environment or scene to another, and differ from the smooth, continuous eye movements exhibited when an observer is tracking a moving object.

During a saccade, light continues to enter the eye and activate photoreceptors in the retina. However, through a cognitive process called saccadic suppression, this light is often not consciously perceived as visible imagery. In other words, the observer does not typically “see” images during a saccade, as light that strikes the retina during the saccade is ignored or suppressed by the visual processing center of brain.

### BRIEF DESCRIPTION OF THE DRAWINGS

FIG. 1 schematically depicts use of an example near-eye display.

FIGS. 2A and 2B schematically depict presentation of image frames to a user of a near-eye display.

FIG. 3 illustrates an example method for mitigation of saccadic breakthroughs.

FIG. 4 schematically depicts display of a series of image frames via a near-eye display.

FIG. 5 schematically depicts detection of movement of a user eye.

FIG. 6 schematically depicts display of saccade-contemporaneous image frames with a temporary saccade-specific image effect.

FIG. 7 schematically depicts an example virtual reality computing device incorporating a near-eye display.

FIG. 8 schematically depicts an example computing system.

### DETAILED DESCRIPTION

When viewing imagery on a near-eye display, users sometimes experience a phenomenon known as a “saccadic breakthrough,” in which the saccadic suppression process described above is disrupted. In particular, images with high spatial or temporal contrast (e.g., a thin, bright line against a dark background) have a tendency to cause saccadic breakthroughs, especially when presented on short-persistence displays. During a saccadic breakthrough, the user may see illusory “ghost” images, and/or images that appear to move with the user's eyes. This can be distracting and disorienting for the user, and can detract from the experience of using a near-eye display.

Accordingly, the present disclosure is directed to mitigating saccadic breakthroughs for head-mounted display devices (HMDs). Specifically, upon detecting movement of a user eye consistent with a saccade, an HMD displays one or more saccade-contemporaneous image frames. These saccade-contemporaneous image frames are displayed with a saccade-specific image effect intended to reduce the likelihood of the saccade-contemporaneous image frames triggering a saccadic breakthrough. Notably, the saccade-specific image effect is temporary, and is not applied to pre-saccade image frames displayed before the eye movement is detected. Thus, in an ideal scenario, the user would be unaware that the saccade-specific image effect was even applied, and would simply continue using the HMD as normal, without experiencing any saccadic breakthroughs. In other words, the herein-described techniques for saccadic breakthrough mitigation improve the functioning of the HMD, as they improve the ability of the HMD to display imagery to a user eye in an appealing manner.

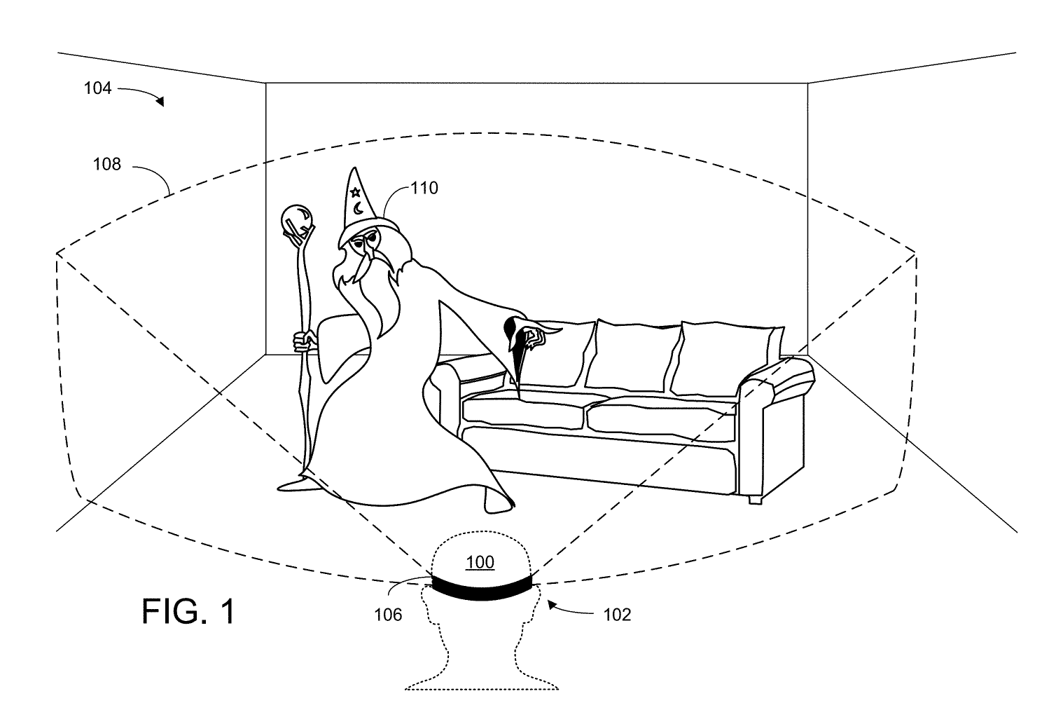

FIG. 1 schematically shows an example user 100 using an HMD 102 to view an environment 104. HMD 102 includes at least one near-eye display 106, configured to present image frames to a user eye. The image frames presented on near-eye display 106 may take any suitable form. For example, image frames may depict a graphical user interface (GUI) of an operating system or software application, a static image (e.g., digital photograph), a pre-recorded video (e.g., a movie), computer-generated imagery (e.g., as part of a video game or animation), etc.

In some examples, image frames may be presented as part of an augmented or virtual reality experience. In the example of FIG. 1, the HMD is providing an augmented reality experience. Near-eye display 106 is at least partially transparent, allowing user 100 to view real objects in environment 104 (e.g., the sofa), as well as computer-generated imagery visible within a field-of-view (FOV) 108 of the near-eye display. As shown, the HMD is rendering and displaying a virtual wizard 110, which is not physically present in environment 104. Rather, HMD 102 is displaying an image frame on near-eye display 106 depicting the virtual wizard, in such a way that the user's brain interprets the virtual wizard as being present. Virtual images, such as virtual wizard 110, may be displayed as a series of image frames presented on the near-eye display that dynamically update as a six degree-of-freedom (6-DOF) pose of the HMD changes. In other words, presentation of image frames may change as the HMD moves relative to environment 104, so as to give the illusion that virtual wizard 110 maintains a physical position within the environment, and/or maintains a constant position relative to the user.

In other words, HMD 102 is an augmented reality computing device that allows user 100 to directly view real-world environment 104 through a partially transparent display. In other examples, near-eye display 106 may be fully opaque and present real-world imagery captured by a camera, a mix of real and virtual imagery, or a fully virtual surrounding environment. To avoid repetition, all of these scenarios are referred to as “virtual reality,” and the computing devices used to provide the augmented or purely virtualized experiences are referred to as virtual reality computing devices.

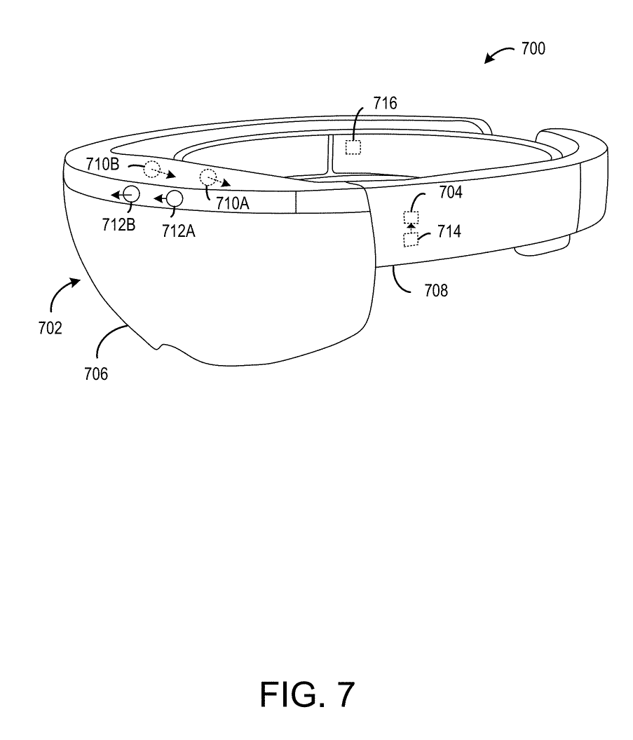

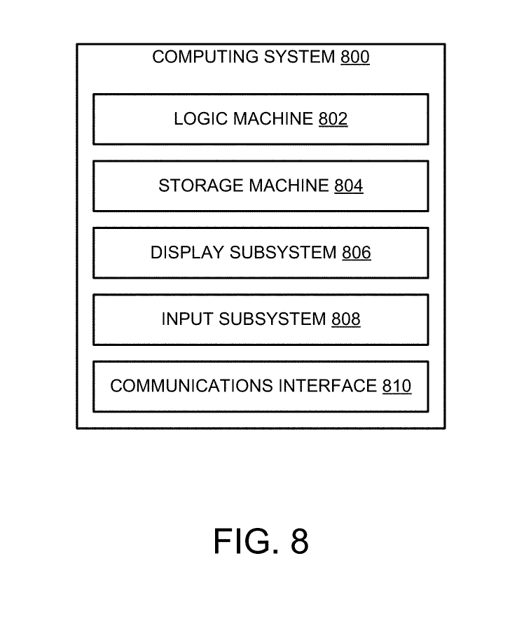

Though the saccadic breakthrough mitigation techniques discussed herein are generally described as being performed by an HMD, devices having other form factors may instead be used. In some examples, image frames may be presented and manipulated via a smartphone or tablet computer, for instance mounted in a brace or sleeve situated in front of a user eye. HMD 102 may be implemented as the virtual reality computing system 700 shown in FIG. 7, and/or the computing system 800 shown in FIG. 8.

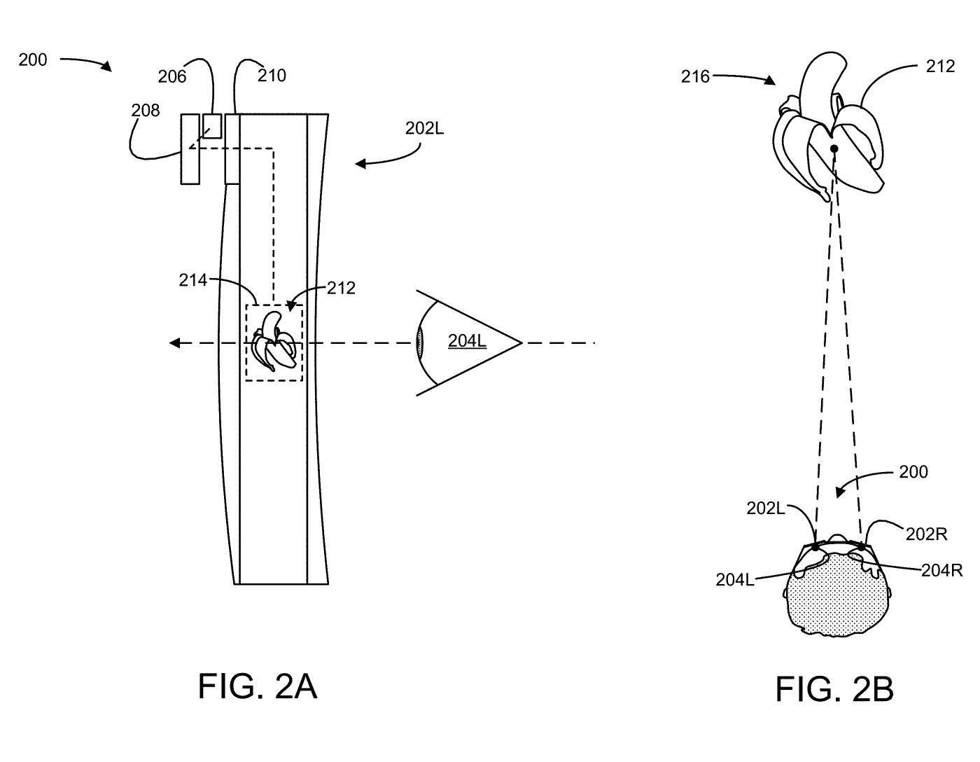

Additional details regarding presentation of image frames on a near-eye display will now be provided with respect to FIGS. 2A and 2B. In some implementations, the near-eye display associated with an HMD may include two or more microprojectors, each configured to project light on or within the near-eye display. FIG. 2A shows a portion of an example near-eye display 200. Near-eye display 200 includes a left microprojector 202L situated in front of a user's left eye 204L. It will be appreciated that near-eye display 200 also includes a right microprojector 202R situated in front of the user's right eye 204R, not visible in FIG. 2A.

The near-eye display includes a light source 206 and a liquid-crystal-on-silicon (LCOS) array 208. The light source may include an ensemble of light-emitting diodes (LEDs)—e.g., white LEDs or a distribution of red, green, and blue LEDs. The light source may be situated to direct its emission onto the LCOS array, which is configured to form a display image based on control signals received from a logic machine associated with an HMD. The LCOS array may include numerous individually addressable display pixels arranged on a rectangular grid or other geometry, each of which is usable to show an image pixel of a display image. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

In some embodiments, the display image from LCOS array 208 may not be suitable for direct viewing by the user of near-eye display 200. In particular, the display image may be offset from the user's eye, may have an undesirable vergence, and/or a very small exit pupil (i.e., area of release of display light, not to be confused with the user's anatomical pupil). In view of these issues, the display image from the LCOS array may be further conditioned en route to the user's eye. For example, light from the LCOS array may pass through one or more lenses, such as lens 210, or other optical components of near-eye display 200, in order to reduce any offsets, adjust vergence, expand the exit pupil, etc.

Light projected by each microprojector 202 may take the form of an image frame visible to a user, occupying a particular screen-space position relative to the near-eye display. As shown, light from LCOS array 208 is forming virtual image frame 212 at screen-space position 214. Specifically, virtual image frame 212 depicts a banana, though any other virtual imagery may be displayed. A similar image may be formed by microprojector 202R, and occupy a similar screen-space position relative to the user's right eye. In some implementations, these two images may be offset from each other in such a way that they are interpreted by the user's visual cortex as a single, three-dimensional image. Accordingly, the user may perceive the images projected by the microprojectors as a three-dimensional object occupying a three-dimensional world-space position that is behind the screen-space position at which the virtual imagery is presented by the near-eye display.

This is shown in FIG. 2B, which shows an overhead view of a user wearing near-eye display 200. As shown, left microprojector 202L is positioned in front of the user's left eye 204L, and right microprojector 202R is positioned in front of the user's right eye 204R. Virtual image frame 212 is visible to the user as a virtual object present at a three-dimensional world-space position 216. In some cases, the user may move the virtual object such that it appears to occupy a different three-dimensional position. Additionally, or alternatively, movement of the user may cause a pose of the HMD to change. In response, the HMD may use different display pixels to present the virtual object so as to give the illusion that the virtual object has not moved relative to the user.

As discussed above, in some cases, users may experience distracting or disorienting visual artifacts when viewing image frames on a near-eye display. For example, if some features of an image frame have relatively high spatial or temporal contrast, the user may experience a saccadic breakthrough while moving their eyes to focus on a different part of the image frame. Thus, the user may perceive illusory “ghost” images, or stationary image content may appear to move with the user's eyes, for example.

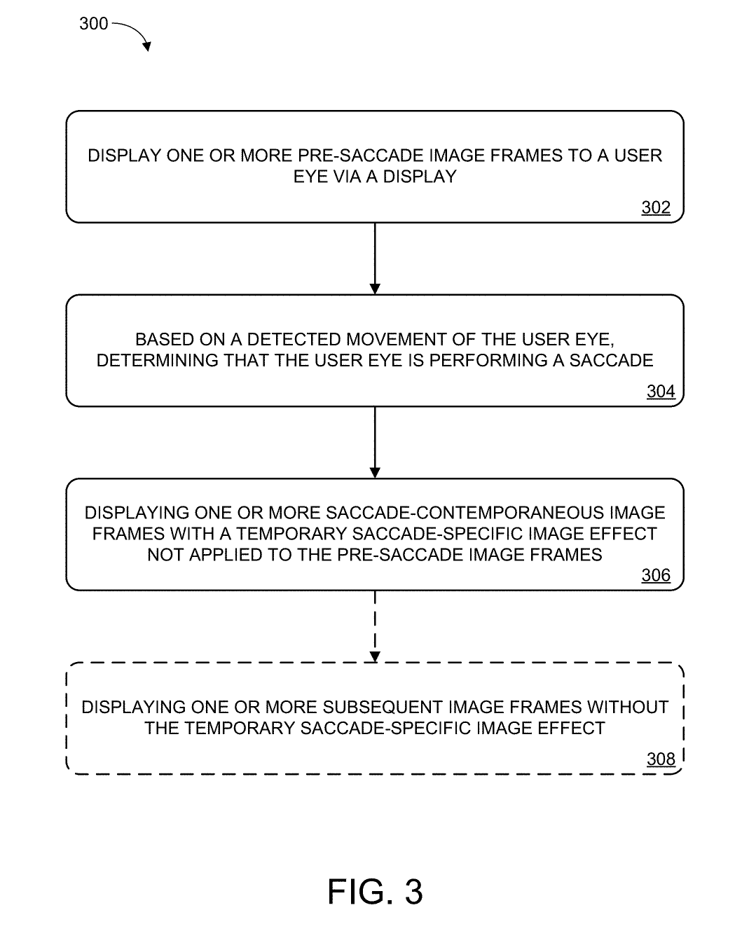

Accordingly, FIG. 3 illustrates an example method 300 for mitigation of saccadic breakthroughs. Method 300 may be implemented on any computer hardware suitable for displaying image frames to a user eye via a display. For example, method 300 may be implemented on an HMD, smartphone, tablet computer, etc. Furthermore, while this disclosure primarily focuses on displaying image frames via a near-eye display, it will be understood that the saccadic breakthrough mitigation techniques described herein may be implemented on any display, regardless of the display's size, form factor, or distance from the user eye. In some examples, method 300 may be implemented on virtual reality computing device 700 described below with respect to FIG. 7, or computing system 800 described below with respect to FIG. 8.

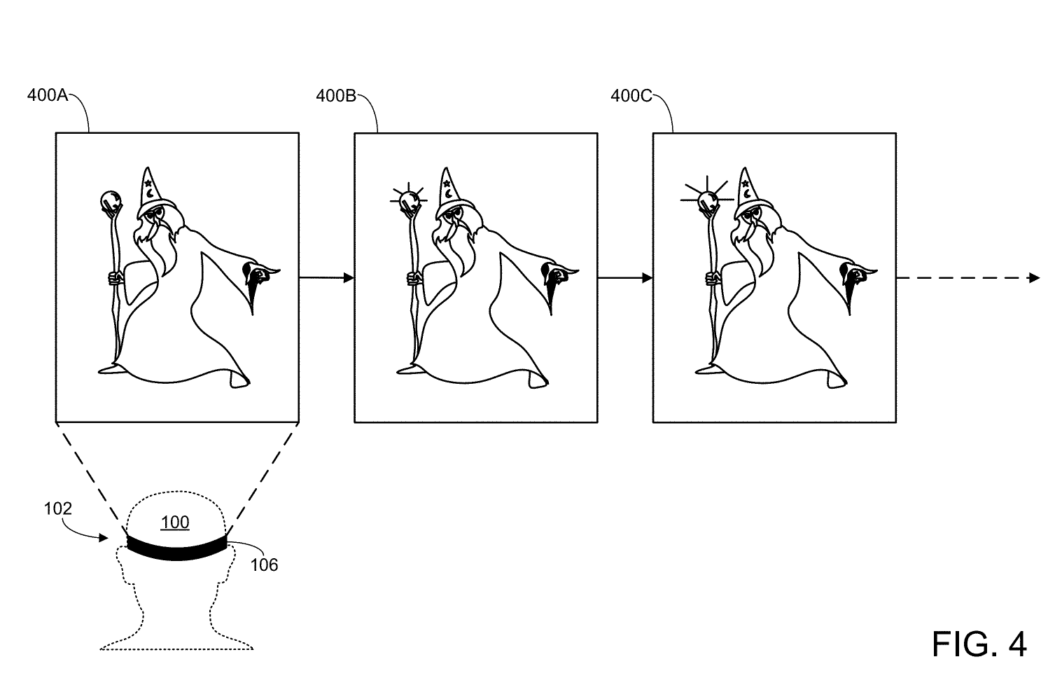

At 302, method 300 includes displaying one or more pre-saccade image frames to a user eye via a display. This is schematically illustrated in FIG. 4, which again shows user 100 wearing HMD 102. In FIG. 4, HMD 102 is currently presenting an image frame to the eyes of user 100 via near-eye display 106. This image frame is shown in FIG. 4 as image frame 400A. As time passes, image frame 400A may be sequentially replaced by image frames 400B and 400C, and so on, for example as part of a movie, animation, virtual reality experience, etc.

The image frames may be presented or updated with any suitable frequency. For example, image frames may be displayed with a frequency of 30 frames per second (FPS), 60 FPS, 120 FPS, etc.

Image frames in FIG. 4 are referred to as “pre-saccade” image frames. In other words, these frames are presented to the user during times when no saccade is detected. Note that a “pre-saccade” image frame may be presented even if one or more previous saccades have already occurred since the user began using the HMD. The term “pre-saccade” is only used to distinguish frames presented during a particular saccade from the frames presented before that saccade was detected. Thus, a pre-saccade image frame may in some cases be presented after a saccade has concluded, though before the next saccade has been detected.

Returning briefly to FIG. 3, at 304, method 300 includes, based on a detected movement of the user eye, determining that the user eye is performing a saccade. “Determining that the user eye is performing a saccade” can include detecting eye movement or other eye-associated conditions that precede, or are associated with initiation of, the saccadic movement itself. Movement of a user eye may be detected in any suitable way, using any suitable eye-tracking technology. In some examples, eye movement may be detected by a gaze tracker as described below with respect to FIG. 7. Gaze tracking may be performed by imaging the iris and/or pupil of an eye using a visible light camera; illuminating the eye with near-infrared or infrared light, and detecting a reflection of this light off the cornea as a glint; and/or other suitable eye tracking techniques.

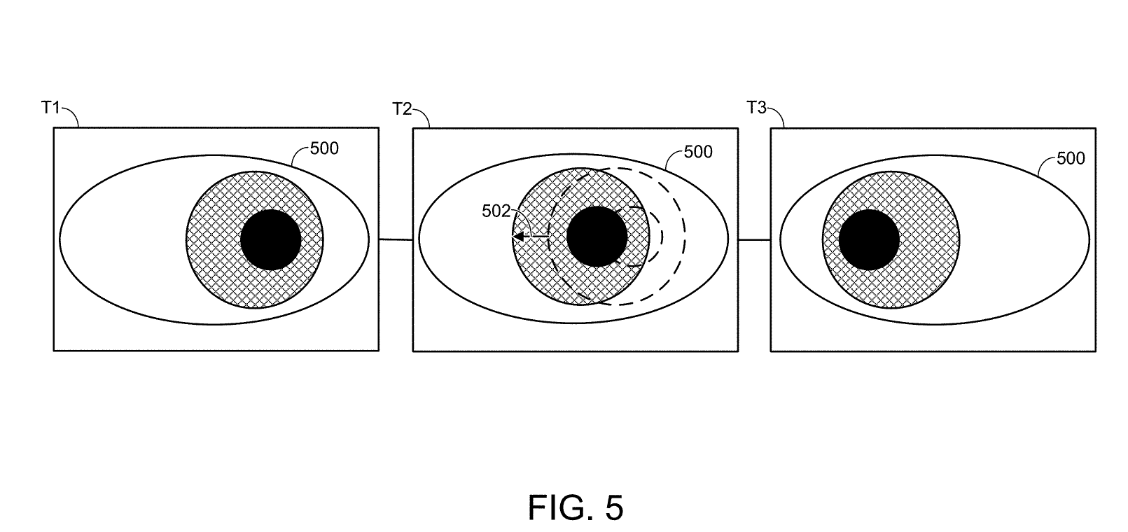

Detection of eye movement is schematically illustrated in FIG. 5, which shows a user eye 500 during three different time frames T1, T2, and T3. At T1, eye 500 is occupying an initial position, with the iris and pupil directed toward the right of the page. At T2, a movement 502 of the eye has been detected, with the iris and pupil moving to the left. The initial positions of the iris and pupil are shown in T2 with dashed lines, to illustrate the extent of the eye's movement. At T3, eye 500 has finished its movement, and the iris and pupil are now directed toward the left of the page.

Depending on the speed and/or duration of the movement of eye 500, it may be classified as a saccade. A typical saccade will last 20-200 ms, and will have an angular velocity of up to 900 degrees per second.

Returning again to FIG. 3, at 306, method 300 includes displaying one or more saccade-contemporaneous image frames with a temporary saccade-specific image effect not applied to the pre-saccade image frames. A temporary saccade-specific image effect can take a variety of forms, and will generally be any image effect that reduces the likelihood that a particular saccade-contemporaneous image frame will trigger a saccadic breakthrough.

In one example, applying the saccade-specific image effect may include removing some or all of the content from one or more image frames. In other words, one or more of the saccade-contemporaneous image frames may be blank—e.g., all pixels in the image frame are set to the same color, such as black.

In another example, applying the saccade-specific image effect may include reducing a brightness of the near-eye display. This may be achieved through hardware and/or software. For instance, a hardware-based reduction in brightness may be achieved by altering the switching frequency of a pulse-width modulated power supply, or altering the near-eye display's voltage regulation. Additionally, or alternatively, software image processing techniques may be applied during rendering of to reduce the brightness of image frames displayed on the near-eye display. For example, the hardware properties of the near-eyed display may be kept constant, while saccade-contemporaneous image frames are rendered differently—e.g., such that one or more pixels in the image frame have a lower brightness value.

Saccadic breakthrough mitigation may be achieved using other image processing techniques in addition to or instead of a reduction in image frame brightness. For example, applying an image processing effect may include applying a blur effect to the one or more saccade-contemporaneous image frames. Blurring can serve to reduce the spatial contrast of an image frame, which can in turn make the image frame less likely to trigger a saccadic breakthrough. Additionally, or alternatively, applying the image processing effect can include reducing spatial contrast in other ways. For instance, an image frame may be rendered such that relatively bright pixels have their brightness decreased, and/or relatively dark pixels have their brightness increased, further reducing the spatial contrast of the image frame.

It will be understood that saccade-specific image effects need not be applied to all pixels in an image frame. In other words, for a saccade-contemporaneous image frame having a plurality of pixels, the image processing effect may be applied to less than all of the plurality of pixels in the image. This may include, for example, only applying the image processing effect to regions within the image frame that have a relatively high likelihood of causing a saccadic breakthrough (e.g., regions having high spatial or temporal contrast).

Furthermore, in some cases, the magnitude of the temporary saccade-specific image effect can vary based on properties of the detected movement of the user eye. In an example scenario, the magnitude of the image effect can be based on a magnitude of the movement—e.g., the magnitude is increased when the eye moves relatively far and/or quickly, and decreased when the eye moves a relatively short distance and/or less quickly, or vice versa. In a different example, when it is detected that the direction of the eye movement is horizontal (i.e., left/right) as opposed to vertical (i.e., up/down), the image processing effect may be applied differently—e.g., directional blurring can be applied, such that pixels values are changed based on the colors of their horizontally-neighboring pixels, though not their vertically-neighboring pixels.

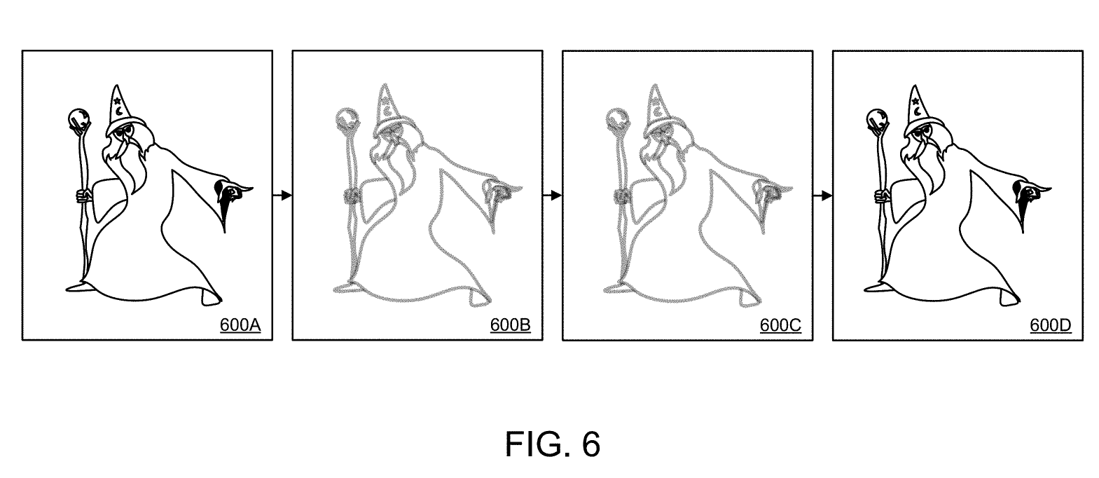

Presentation of saccade-contemporaneous image frames is schematically depicted in FIG. 6. Specifically, FIG. 6 shows a series of image frames 600A-600D presented to a user eye via a near-eye display. Image frame 600A is a pre-saccade image frame, and is presented without a temporary saccade-specific image effect. However, image frames 600B and 600C are saccade-contemporaneous image frames. In other words, they are presented after an eye movement has been detected that is consistent with a saccade. Accordingly, the spatial contrast of these image frames has been reduced (i.e., via application of an image processing effect as described above). Thus, image frames 600B and 600C may be less likely to trigger a saccadic breakthrough.

Returning briefly to FIG. 3, at 308, method 300 optionally includes displaying one or more subsequent image frames without the temporary saccade-specific image effect. As shown in FIG. 6, the temporary saccade-specific image effect is applied to two saccade-contemporaneous image frames, and is not applied to image frame 600D. However, it will be understood that the temporary saccade-specific image effect may be applied for any duration, and/or to any number of image frames. In one example, the temporary saccade-specific image effect may be ended after detecting an end to the movement of the user eye. In other words, after detecting that the eye has remained stationary for a period of time (e.g., some number of time frames), one or more subsequent image frames may be presented without the temporary saccade-specific image effect.

In a different example, the temporary saccade-specific image effect may be applied to all image frames during an expected saccade duration. In other words, once the expected saccade duration has elapsed, one or more subsequent image frames may be displayed without the temporary saccade-specific image effect. The length of the expected saccade duration may be set in any suitable way. In some examples, the expected saccade duration may be a static, preset length of time (e.g., the average length of a human saccade). Typically, the length of a human saccade will range from 20-200 ms, with saccades observed during reading text ranging from 20-30 ms. In other examples, the expected saccade duration may be tailored to a specific user (e.g., an observed average saccade duration for the specific user), and/or may differ based on detected properties of the eye movement. For example, a length of the expected saccade duration may be set based on a magnitude of the saccade.

It will be understood that, regardless of how long the temporary saccade-specific image effect is applied for, it will be applied to at least one saccade-contemporaneous image frames. However, in some cases, the temporary saccade-contemporaneous image effect may end before the saccade does (e.g., if the expected saccade duration is shorter than the actual saccade duration), or be applied to one or more image frames presented after the saccade has ended (e.g., if the expected saccade duration is longer than the actual saccade duration).

As discussed above, in some cases the saccadic breakthrough mitigation techniques described herein may be implemented on a virtual reality computing device. FIG. 7 shows aspects of an example virtual-reality computing system 700 including a near-eye display 702. The virtual-reality computing system 700 is a non-limiting example of the virtual-reality computing devices described above, and may be usable for displaying and modifying virtual imagery. Virtual reality computing system 700 may be implemented as computing system 800 shown in FIG. 8.

The virtual-reality computing system 700 may be configured to present any suitable type of virtual-reality experience. In some implementations, the virtual-reality experience includes a totally virtual experience in which the near-eye display 702 is opaque, such that the wearer is completely absorbed in the virtual-reality imagery provided via the near-eye display 702. In other implementations, the virtual-reality experience includes an augmented-reality experience in which the near-eye display 702 is wholly or partially transparent from the perspective of the wearer, to give the wearer a clear view of a surrounding physical space. In such a configuration, the near-eye display 702 is configured to direct display light to the user's eye(s) so that the user will see augmented-reality objects that are not actually present in the physical space. In other words, the near-eye display 702 may direct display light to the user's eye(s) while light from the physical space passes through the near-eye display 702 to the user's eye(s). As such, the user's eye(s) simultaneously receive light from the physical environment and display light.

In such augmented-reality implementations, the virtual-reality computing system 700 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the virtual-reality computing system 700 changes. As such, a body-locked, augmented-reality object may appear to occupy the same portion of the near-eye display 702 and may appear to be at the same distance from the user, even as the user moves in the physical space. Alternatively, a world-locked, augmented-reality object may appear to remain in a fixed location in the physical space, even as the pose of the virtual-reality computing system 700 changes.

In some implementations, the opacity of the near-eye display 702 is controllable dynamically via a dimming filter. A substantially see-through display, accordingly, may be switched to full opacity for a fully immersive virtual-reality experience.

The virtual-reality computing system 700 may take any other suitable form in which a transparent, semi-transparent, and/or non-transparent display is supported in front of a viewer's eye(s). Further, implementations described herein may be used with any other suitable computing device, including but not limited to wearable computing devices, mobile computing devices, laptop computers, desktop computers, smart phones, tablet computers, etc.

Any suitable mechanism may be used to display images via the near-eye display 702. For example, the near-eye display 702 may include image-producing elements located within lenses 706. As another example, the near-eye display 702 may include a display device, such as a liquid crystal on silicon (LCOS) device or OLED microdisplay located within a frame 708. In this example, the lenses 706 may serve as, or otherwise include, a light guide for delivering light from the display device to the eyes of a wearer. Additionally, or alternatively, the near-eye display 702 may present left-eye and right-eye virtual-reality images via respective left-eye and right-eye displays.

The virtual-reality computing system 700 includes an on-board computer 704 configured to perform various operations related to receiving user input (e.g., gesture recognition, eye gaze detection), visual presentation of virtual-reality images on the near-eye display 702, and other operations described herein. In some implementations, some to all of the computing functions described above, may be performed off board.

The virtual-reality computing system 700 may include various sensors and related systems to provide information to the on-board computer 704. Such sensors may include, but are not limited to, one or more inward facing image sensors 710A and 710B, one or more outward facing image sensors 712A and 712B, an inertial measurement unit (IMU) 714, and one or more microphones 716. The one or more inward facing image sensors 710A, 710B may be configured to acquire gaze tracking information from a wearer's eyes (e.g., sensor 710A may acquire image data for one of the wearer's eye and sensor 710B may acquire image data for the other of the wearer's eye).

The on-board computer 704 may be configured to determine gaze directions of each of a wearer's eyes in any suitable manner based on the information received from the image sensors 710A, 710B. The one or more inward facing image sensors 710A, 710B, and the on-board computer 704 may collectively represent a gaze detection machine configured to determine a wearer's gaze target on the near-eye display 702. In other implementations, a different type of gaze detector/sensor may be employed to measure one or more gaze parameters of the user's eyes, including, for example, electrooculography (EOG). Examples of gaze parameters measured by one or more gaze sensors that may be used by the on-board computer 704 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 712A, 712B may be configured to measure physical environment attributes of a physical space. In one example, image sensor 712A may include a visible-light camera configured to collect a visible-light image of a physical space. Further, the image sensor 712B may include a depth camera configured to collect a depth image of a physical space. More particularly, in one example, the depth camera is an infrared time-of-flight depth camera. In another example, the depth camera is an infrared structured light depth camera.

Data from the outward facing image sensors 712A, 712B may be used by the on-board computer 704 to detect movements, such as gesture-based inputs or other movements performed by a wearer or by a person or physical object in the physical space. In one example, data from the outward facing image sensors 712A, 712B may be used to detect a wearer input performed by the wearer of the virtual-reality computing system 700, such as a gesture. Data from the outward facing image sensors 712A, 712B may be used by the on-board computer 704 to determine direction/location and orientation data (e.g., from imaging environmental features) that enables position/motion tracking of the virtual-reality computing system 700 in the real-world environment. In some implementations, data from the outward facing image sensors 712A, 712B may be used by the on-board computer 704 to construct still images and/or video images of the surrounding environment from the perspective of the virtual-reality computing system 700.

The IMU 714 may be configured to provide position and/or orientation data of the virtual-reality computing system 700 to the on-board computer 704. In one implementation, the IMU 714 may be configured as a three-axis or three-degree of freedom (3DOF) position sensor system. This example position sensor system may, for example, include three gyroscopes to indicate or measure a change in orientation of the virtual-reality computing system 700 within 3D space about three orthogonal axes (e.g., roll, pitch, and yaw).

In another example, the IMU 714 may be configured as a six-axis or six-degree of freedom (6DOF) position sensor system. Such a configuration may include three accelerometers and three gyroscopes to indicate or measure a change in location of the virtual-reality computing system 700 along three orthogonal spatial axes (e.g., x, y, and z) and a change in device orientation about three orthogonal rotation axes (e.g., yaw, pitch, and roll). In some implementations, position and orientation data from the outward facing image sensors 712A, 712B and the IMU 714 may be used in conjunction to determine a position and orientation (or 6DOF pose) of the virtual-reality computing system 700.

The virtual-reality computing system 700 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

The one or more microphones 716 may be configured to measure sound in the physical space. Data from the one or more microphones 716 may be used by the on-board computer 704 to recognize voice commands provided by the wearer to control the virtual-reality computing system 700.

The on-board computer 704 may include a logic machine and a storage machine, discussed in more detail below with respect to FIG. 8, in communication with the near-eye display 702 and the various sensors of the virtual-reality computing system 700.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), wearable devices, virtual reality computing devices, head-mounted display devices, and/or other computing devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally, or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

In an example, a method for mitigation of saccadic breakthroughs comprises: displaying one or more pre-saccade image frames to a user eye via a display; based on a detected movement of the user eye, determining that the user eye is performing a saccade; and displaying one or more saccade-contemporaneous image frames with a temporary saccade-specific image effect not applied to the pre-saccade image frames. In this example or any other example, the temporary saccade-specific image effect is a reduction in brightness of the display. In this example or any other example, the temporary saccade-specific image effect is an image processing effect applied during rendering of the one or more saccade-contemporaneous image frames. In this example or any other example, the image processing effect is a blur effect. In this example or any other example, the image processing effect is a reduction in spatial contrast of the one or more saccade-contemporaneous image frames. In this example or any other example, each of the one or more saccade-contemporaneous image frames includes a plurality of image pixels, and the image processing effect is applied to less than all of the plurality of pixels of the one or more saccade-contemporaneous image frames. In this example or any other example, a magnitude of the temporary saccade-specific image effect is based on a magnitude of the saccade. In this example or any other example, the one or more saccade-contemporaneous image frames are blank. In this example or any other example, the method further comprises, based on detecting an end to the movement of the user eye, displaying one or more subsequent image frames without the temporary saccade-specific image effect. In this example or any other example, the method further comprises, after an expected saccade duration has elapsed, displaying one or more subsequent image frames without the temporary saccade-specific image effect. In this example or any other example, a length of the expected saccade duration is based on a magnitude of the saccade.

In an example, a head-mounted display device comprises: a display; a logic machine; and a storage machine holding instructions executable by the logic machine to: display one or more pre-saccade image frames to a user eye via the display; based on a detected movement of the user eye, determine that the user eye is performing a saccade; and display one or more saccade-contemporaneous image frames with a temporary saccade-specific image effect not applied to the pre-saccade image frames. In this example or any other example, the display is a near-eye display, and the temporary saccade-specific image effect is a reduction in brightness of the near-eye display. In this example or any other example, the temporary saccade-specific image effect is an image processing effect applied during rendering of the one or more saccade-contemporaneous image frames. In this example or any other example, each of the one or more saccade-contemporaneous image frames includes a plurality of image pixels, and the image processing effect is applied to less than all of the plurality of pixels of the one or more saccade-contemporaneous image frames. In this example or any other example, the image processing effect is a reduction in spatial contrast. In this example or any other example, the instructions are further executable to, based on detecting an end to the movement of the user eye, display one or more subsequent image frames without the temporary saccade-specific image effect. In this example or any other example, the instructions are further executable to, after an expected saccade duration has elapsed, display one or more subsequent image frames without the temporary saccade-specific image effect. In this example or any other example, a length of the expected saccade duration is based on a magnitude of the saccade.

In an example, a method for mitigation of saccadic breakthroughs comprises: displaying one or more pre-saccade image frames to a user eye via a near-eye display; based on a detected movement of the user eye, determining that the user eye is performing a saccade; displaying one or more saccade-contemporaneous image frames with a temporary blur effect not applied to the pre-saccade image frames, a magnitude of the temporary blur effect being based on a magnitude of the saccade; and after an expected saccade duration has elapsed, such duration being based on the magnitude of the saccade, displaying one or more subsequent image frames without the temporary blur effect.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for mitigation of saccadic breakthroughs, comprising:
displaying one or more pre-saccade image frames to a user eye via a display;
based on a detected movement of the user eye, determining that the user eye is performing a saccade;
displaying one or more saccade-contemporaneous image frames with a temporary saccade-specific image effect not applied to the pre-saccade image frames; and
after an expected saccade duration has elapsed, displaying one or more subsequent image frames without the temporary saccade-specific image effect.

2. The method of claim 1, where the temporary saccade-specific image effect is a reduction in brightness of the display.

3. The method of claim 1, where the temporary saccade-specific image effect is an image processing effect applied during rendering of the one or more saccade-contemporaneous image frames.

4. The method of claim 3, where the image processing effect is a blur effect.

5. The method of claim 3, where the image processing effect is a reduction in spatial contrast of the one or more saccade-contemporaneous image frames.

6. The method of claim 3, where each of the one or more saccade-contemporaneous image frames includes a plurality of image pixels, and the image processing effect is applied to less than all of the plurality of pixels of the one or more saccade-contemporaneous image frames.

7. The method of claim 1, where a magnitude of the temporary saccade-specific image effect is based on a magnitude of the saccade.

8. The method of claim 1, where the one or more saccade-contemporaneous image frames are blank.

9-10. (canceled)

11. The method of claim 1, where a length of the expected saccade duration is based on a magnitude of the saccade.

12. A head-mounted display device, comprising:
a display;
a logic machine; and
a storage machine holding instructions executable by the logic machine to:
display one or more pre-saccade image frames to a user eye via the display;
based on a detected movement of the user eye, determine that the user eye is performing a saccade;
display one or more saccade-contemporaneous image frames with a temporary saccade-specific image effect not applied to the pre-saccade image frames; and
after an expected saccade duration has elapsed, display one or more subsequent image frames without the temporary saccade-specific image effect.

13. The head-mounted display device of claim 12, where the display is a near-eye display, and the temporary saccade-specific image effect is a reduction in brightness of the near-eye display.

14. The head-mounted display device of claim 12, where the temporary saccade-specific image effect is an image processing effect applied during rendering of the one or more saccade-contemporaneous image frames.

15. The head-mounted display device of claim 14, where each of the one or more saccade-contemporaneous image frames includes a plurality of image pixels, and the image processing effect is applied to less than all of the plurality of pixels of the one or more saccade-contemporaneous image frames.

16. The head-mounted display device of claim 14, where the image processing effect is a reduction in spatial contrast.

17-18. (canceled)

19. The head-mounted display device of claim 14, where a length of the expected saccade duration is based on a magnitude of the saccade.

20. A method for mitigation of saccadic breakthroughs, comprising:
displaying one or more pre-saccade image frames to a user eye via a near-eye display;
based on a detected movement of the user eye, determining that the user eye is performing a saccade;
displaying one or more saccade-contemporaneous image frames with a temporary blur effect not applied to the pre-saccade image frames, a magnitude of the temporary blur effect being based on a magnitude of the saccade; and
after an expected saccade duration has elapsed, such duration being based on the magnitude of the saccade, displaying one or more subsequent image frames without the temporary blur effect.
